(19) United States
(12) Patent Application Publication
(10) Pub. No.: US 2026/0097480 A1
(43) Pub. Date: Apr. 9, 2026

(54) LOW-PROFILE CLAMP, GUIDE AND ANCHORS WITH EXPANDABLE DOGS

(71) Applicant: Bow Products Inc, Superior, CO (US)

(72) Inventors: D. Keith Bow, Corfu, NY (US); William Fudale, Superior, CO (US)

(73) Assignee: Bow Products Inc, Superior, CO (US)

(21) Appl. No.: 19/346,183

(22) Filed: Sep. 30, 2025

Related U.S. Application Data
(60) Provisional application No. 63/704,881, filed on Oct. 8, 2024.

(51) Int. Cl. B25H 1/08; B25H 1/10

(52) U.S. Cl. CPC B25H 1/08; B25H 1/10

(57) ABSTRACT

Various individual, configurable, and combinations of clamping and guide apparatus are disclosed along with releasable anchoring mechanisms such as T-bolts and a dog hole anchor that may be used interchangeably with the clamps and guides.

This application claims priority under 35 U.S.C. § 119 (e) to U.S. Provisional Patent Application No. 63/704,881, for a LOW-PROFILE CLAMP, GUIDE, ANCHORS AND KIT, filed Oct. 8, 2024 by D. Keith Bow and William Fudale, which is hereby incorporated by reference in its entirety.

Disclosed herein are both individual and combinations of clamping and guide apparatus for use when positioning workpieces on a work surface, including dog-style anchoring mechanisms that may be used interchangeably to releasably attach the clamps and guides to the work surface.

### BACKGROUND AND SUMMARY

The need to control the position of a workpiece, such as a piece of wood or other material, when undergoing forming operations such as cutting, drilling, routing, etc. is known. The various embodiments of tools disclosed herein address such needs with one or more, or a combination of clamps and guides. Each of the disclosed tools may be releasably attached to a work surface using an anchor, preferably a releasable anchor to facilitate adjustment of the clamp or guide relative to the workpiece.

Disclosed in embodiments herein is a clamp apparatus including: a clamp base having an adjustment slot or slit therein; a releasable anchor, operatively associated with and passing through the adjustment slot, to attach the clamp base to a work surface; and a removable tip for attachment on the end of the clamp base for contact with a workpiece.

Further disclosed in embodiments herein is a movable guide for use on a work surface comprising: a central web spanning between at least two opposite edges, wherein at least one of the edges includes a ribbed surface for contact with a workpiece; a slot or slit located in the web; and an anchor, adjustably associated with the adjustment slot, for releasably positioning the guide relative to a dog hole in a work surface.

Also disclosed herein is a releasable anchor, for use with a dog hole in a work surface, comprising: two expansion components; and a threaded fastener (e.g., bolt) passing therethrough, the anchor being suitable for insertion into the dog hole and expanding to provide a releasably contact to the work surface.

Further disclosed in embodiments herein is a kit comprising: at least one clamp apparatus with a plurality of removable tips; at least one movable guide; at least one anchor; and at least one handle (e.g., knob, driver handle, etc.) to tighten the at least one anchor.

### BRIEF DESCRIPTION OF THE DRAWINGS

FIGS. 1-4 are, respectively, perspective, top, side and bottom views of a low-profile clamp apparatus including a clamp base and associated removable tips for attachment on the end of the clamp base for contact with a workpiece;

FIGS. 5A-5D are side, cross-section and perspective views of the clamp apparatus with a threaded screw as an anchor;

FIGS. 6A-6D are side, cross-section and perspective views of the clamp apparatus with a T-bolt style anchor;

FIGS. 7A-7B are side and cross-section views of the clamp apparatus having a short T-bolt style anchor;

FIGS. 8A-8D are side, cross-section and perspective views of the clamp apparatus with an expandable dog anchor for use in conjunction with a dog hole of a work surface;

FIGS. 9A-9G are various views of a movable guide with a dog anchor for use in conjunction with a dog hole of a work surface;

FIG. 10 is a perspective view of two inter-related expansion components of the dog anchor;

FIG. 11 is a perspective view of the two inter-related expansion components of the dog anchor with an optional spring therebetween;

FIGS. 12A and 12B respectively show the assembly of FIG. 11 in a nominal (non-expanded) state and an expanded state;

FIG. 13 is an illustrative cross-sectional view of the use of the dog anchor; and

FIG. 14 is a top view of a kit comprising multiple clamps, guides and various anchors and adjustment knobs and the like for use on a work surface(s).

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

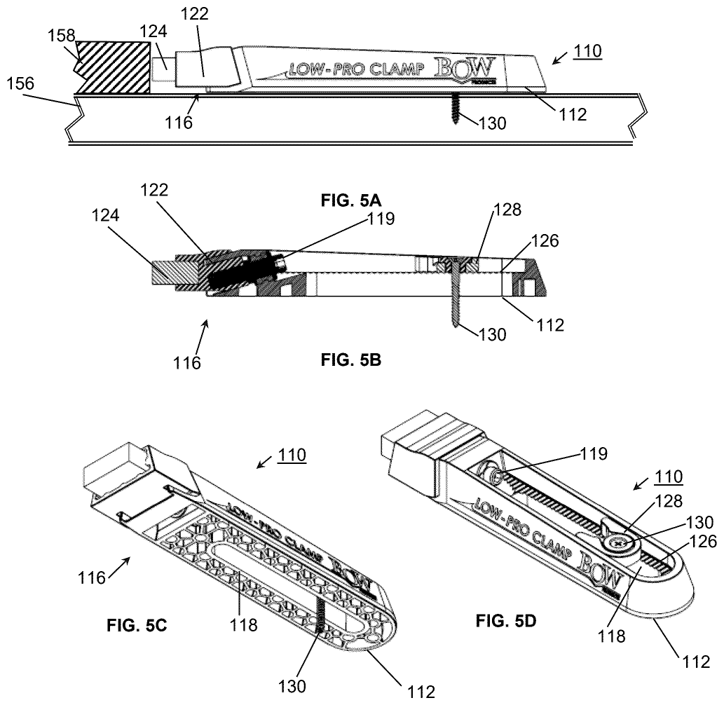

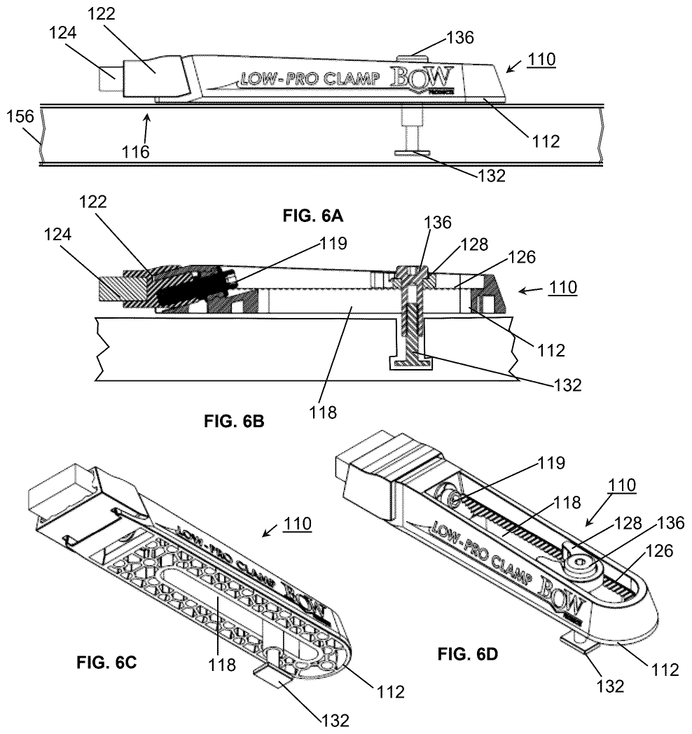

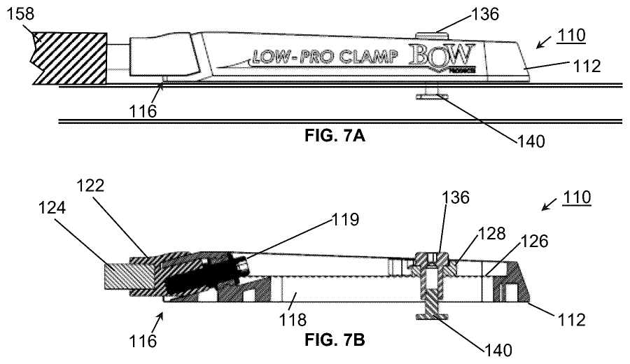

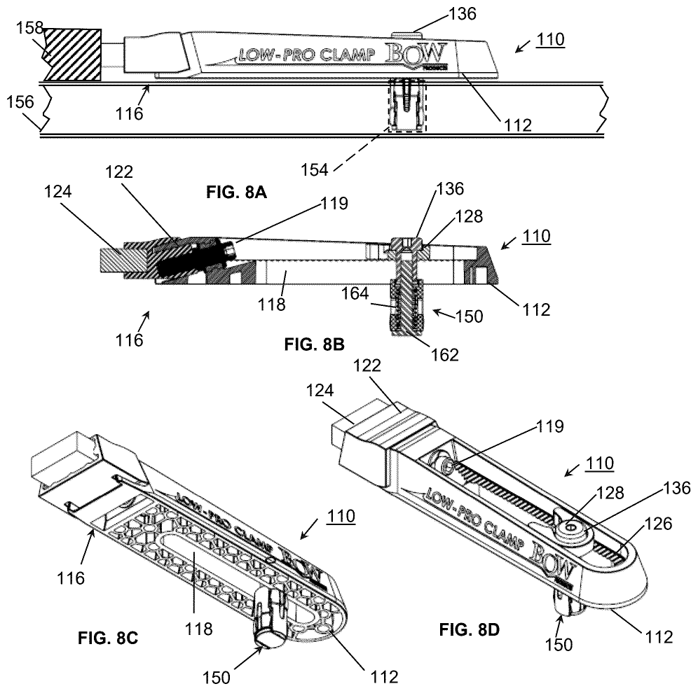

Turning to the figures, FIGS. 1-4 show, respectively, perspective, top, side and bottom views of a low-profile clamp apparatus 110 including a clamp base 112 and associated removable tips 114A-D for attachment on end 116 of the clamp base for contact with a workpiece (e.g., FIG. 5A; 190). FIGS. 5A-5D are side, cross-section and perspective views of the clamp apparatus 110 with a threaded screw 130 as an anchor. FIGS. 6A-6D are side, cross-section and perspective views of the clamp apparatus with a T-bolt style anchor 132. FIGS. 7A-7B are side and cross-sectional views of the clamp apparatus using a shorter T-bolt style anchor 140. FIGS. 8A-8D are side, cross-section and perspective views of the clamp apparatus 110 with an expandable dog anchor 150 for use in a dog hole 154 of a work surface 156.

Considering FIGS. 1-8D as generally described above, the embodiments of clamp apparatus 110 will now be further described. The clamp apparatus generally the clamp base 112, which has an adjustment slot or slit 118 running longitudinally along the middle of the base, which may be made from molded plastic, metal, etc. The low-profile clamp base 112 is made from a material such as metal alloys or polymers, which may be manufactured using processes such as injection molding, 3D-printing, machining, etc., providing a rigid structure for the base. As illustrated in the figures, a releasable and interchangeable anchor (e.g., 130, 132, 140 or 150) is operatively associated with and passes through the adjustment slot, to attach the clamp base 110 to a work surface. The selection of an appropriate anchor is, to some extent dependent upon the type and configuration of the work surface 156.

Another feature of the low-profile clamp apparatus 110 is a removable tip (114A-D) for attachment on the end of the clamp base for contact with a workpiece. In one embodiment the rigid portion of the removable tips 114A-D includes a receptacle for receiving the end 116 of the clamp base 112. While various methods of attachment may be employed to releasably connect the tips to the base (e.g., snap-fit, interference fit, etc.), the disclosed embodiment employs a threaded bolt 119, such as a socket head cap screw, that passes through the front of the clamp base and is threadedly engaged within recess 120 of the removable tips 114A-D.

The removable tips may also include a rigid portion 122 that connects with or contacts the clamp base 112 and a resilient or conformable portion 124 (e.g., made of an EVA foam or similar material) for contacting a workpiece. And, as illustrated in figures, the resilient portion 124 has a contact surface for engaging or clamping a workpiece. For example, tips may be selected from the group of a flat surface on tip 114A, a ribbed surface on tip 114B, a low-profile surface on tip 114C, and a surface having an array of protrusions as on tip 114D.

The clamp apparatus 110 may be attached to the work surface 156 using any of a number of anchors such as a threaded screw 130, a T-bolt 132 or 140 with a threaded tightening knob 134 or a barrel nut 136, and a dog-hole suitable anchor (dog-style anchor) 150. The dog-style expandable anchor embodiment 150 is described in more detail relative to FIGS. 10-13 below.

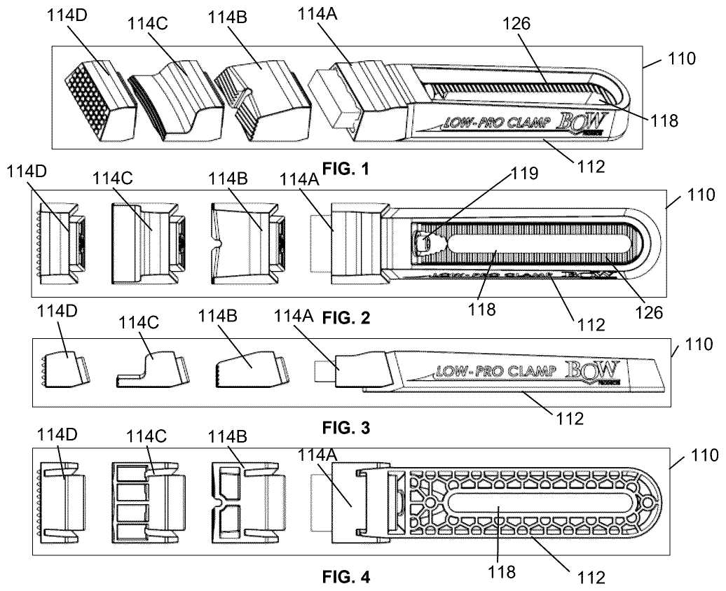

As further illustrated in the top view of FIG. 2, the linear adjustment slot 118 is surrounded by a high-friction surface 126 and at least a portion of the releasable anchor contacts the high-friction surface to hold the clamp base in place when attached to the work surface. As illustrated in the longitudinal cross sections of FIGS. 5B, 6B, 7B and 8B the high-friction surface includes a plurality of parallel ridges/grooves along and extending outward from the sides of the adjustment slot. Moreover, the releasable anchor in each embodiment further includes an anchor retaining collar 128 having a recess for receiving the head of the anchor screw or bolt passing therethrough and a complimentary ridged under-side for frictional or meshed contact with the parallel ridges of surface 126.

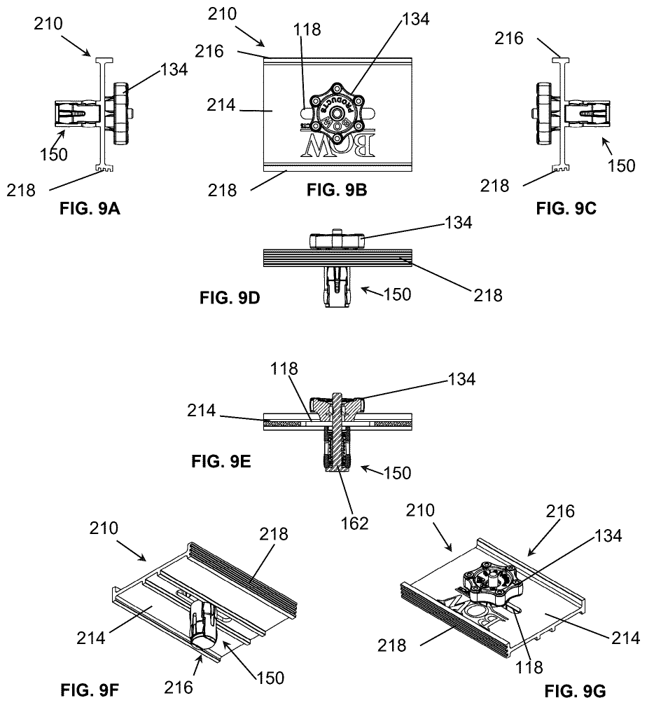

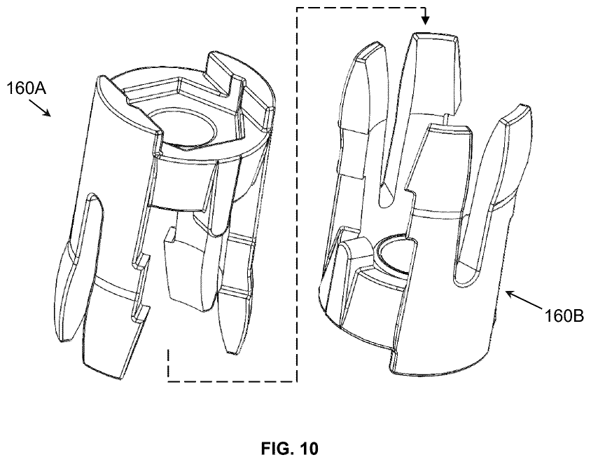

FIGS. 9A-9G are various views of a movable guide 210 with an expandable dog anchor 150 for insertion into a dog hole 154 of a work surface to retain the position and orientation of the guide. The movable guide 210 is made from a material such as a metal alloy or polymer, which may be manufactured using processes such as injection molding, 3D-printing, machining, etc., providing a rigid structure for the guide.

The movable guide 210 is intended for use on a work surface 156. The guide includes a central web 214 spanning between at least two opposite edges 216 and 218, where at least one of the edges includes a ribbed surface for contact with a workpiece 158. The web has a slot(s) or a slit(s) in it to allow for the insertion of an anchor to releasably attach the guide to the work surface 156. And the anchor (130, 132, 140 or 150) is adjustably associated with the adjustment slot, for releasably positioning an edge of the guide, for example, relative to a dog hole or a T-slot in the work surface. In such an embodiment, where the anchor used is an expandable dog anchor 150, the anchor may be constructed as described in detail below relative to FIGS. 10-13.

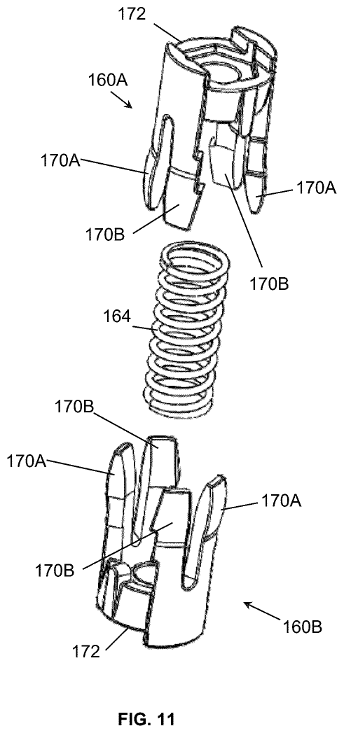

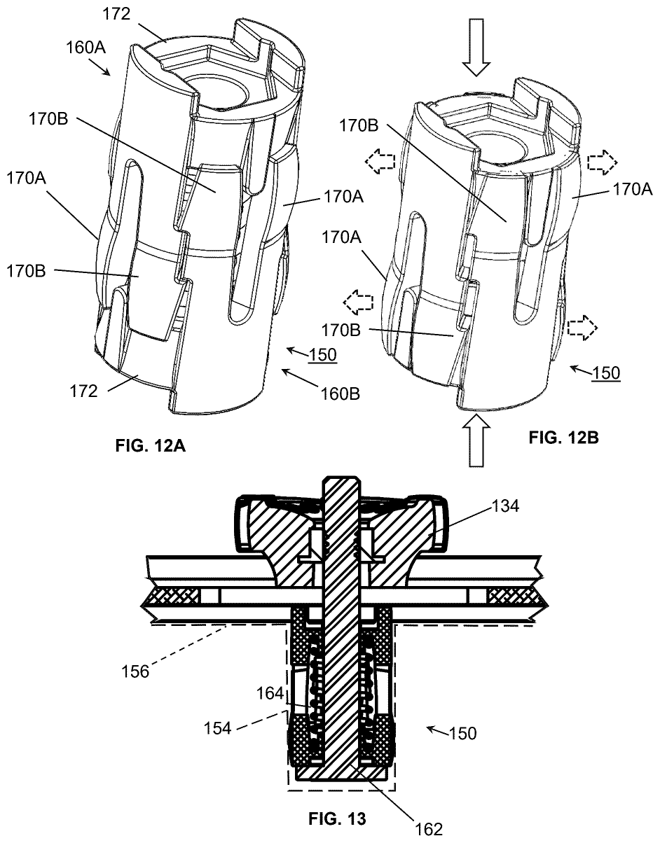

FIG. 10 is a perspective view of two inter-related expansion components 160A, B of the expandable dog anchor 150. FIG. 11 is a perspective view of the two inter-related expansion components 160A, B of the dog anchor 150 with an optional spring 164 therebetween. FIGS. 12A and 12B, respectively, show the component assembly of dog anchor 150 in a nominal (non-expanded) state and an expanded state. FIG. 13 is an illustrative cross-sectional view of the use of the dog anchor 150.

The releasable, expandable dog hole anchor 150, for use with a dog hole 154 in work surface 156, includes two expansion components 160A, B and an adjustable fastener such as a threaded through-bolt 162 (e.g., a ¼-20 T-Bolt) with a threaded knob 134. It should be appreciated that various alternative fasteners may be employed to provide the necessary compressive force. For example, a shaft having an expanded head at the lower end, and a cam-type component at the top to apply the compressive force on the expansion components 160A and 160B. The expandable dog hole anchor is made from a resilient, albeit deformable, material such as polymers (e.g., thermoplastic polymers such as polypropylenes, glass filled Nylon, etc.), which may be manufactured using processes such as injection molding, 3D-printing, machining, etc. In one embodiment, the dog hole anchor or dog fits dog tables with dog holes of approximately 0.75 inch or 19-20 mm in diameter with a depth of at least 0.25 inches.

The combination of the expansion components and through-bolt or similar fastener is suitable for insertion into the dog hole and, as the through-bolt is tightened by knob 134, where the two expansion components 160A, B contact one another and expand to provide a releasable contact to the work surface, or more specifically, the hole in the surface. In one embodiment, the two expansion components are identical in shape and one is reversed relative to, and overlaps, the other as illustrated in FIG. 12A, for example. The use of identical components, albeit reversed in orientation, allows for the economical manufacture and inventory of only a one expansion component design. As further illustrated, fingers 170A, B of the two expansion components 160A, B are in contact when compressed longitudinally, creating an outward radial force against the walls of the dog hole. For each of the expansion components 160A and 160B, fingers 170A and 170B each extend from a cylindrical collar 172, which has a hole through its center for passage of the bolt or fastener 162. The fingers of the opposed expansion components interfere as the respective collars are moved toward one another by a compressive force from the bolt and knob being tightened, in other words pushing the respective collars of components 160A and 160B toward one another, and the interference causes the fingers to deflect and expand outward to contact a wall of the dog hole 154.

The fingers 170A, B, each have at least one notch or shoulder thereon, the shoulder interlocking with an adjacent finger of the opposed expansion component to connect the two expansion components around the bolt. In one embodiment, the expandable dog anchor 150 may also include a spring 164, located around the bolt and positioned between the collars of the opposed expansion components to bias expansion components 160A and 160B away from one another when the components are in a non-expanded state.

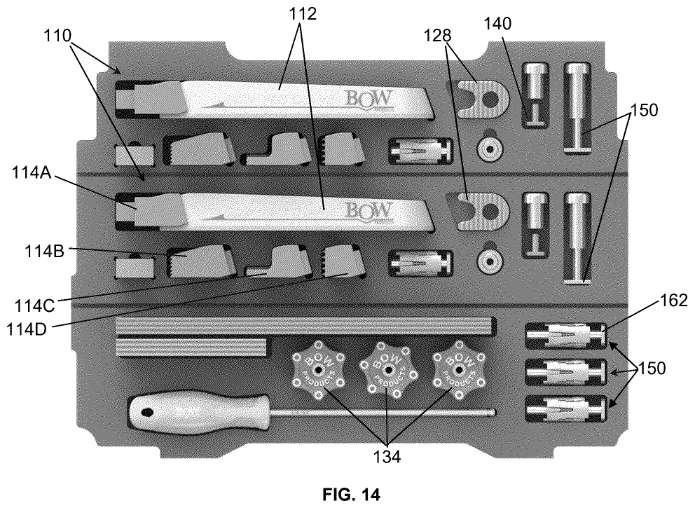

FIG. 14 is a top view of a kit 310 providing various interchangeable and related components for use in woodworking and other material-forming operations. In one embodiment the kit comprises multiple clamps 110, guides 210 and various anchors 132, 140 and 150, adjustment knobs 180 and handle 184, and the like for use on work surface(s).

As should be appreciated, the various components described above may be interchangeably mixed and used for various clamping and guiding operations. According, the components may be assembled in a kit, as illustrated in FIG. 14, that includes: at least one clamp apparatus with a plurality of removable tips; at least one movable guide; at least one anchor; and at least one handle (e.g., knob 134, driver handle 180) to tighten the at least one anchor. And, in one embodiment, the anchor includes an expandable dog anchor 150, for use with a dog hole 154 of a work surface 156. And, the kit also includes at least one T-bolt 132 and/Or 140 for use in anchoring the clamp or guide in a T-slot of the work surface 156.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

Reference Numbers Used:

| Ref # | Item |
|---|---|
| 110 | clamp apparatus |
| 112 | clamp base |
| 114A-D | removable tips |
| 116 | clamp base end |
| 118 | adjustment slot |
| 119 | fastener (e.g. threaded bolt) |
| 122 | rigid portion |
| 124 | resilient portion |
| 126 | high-friction surface |
| 128 | anchor retaining collar |
| 130 | threaded screw |
| 132 | T-bolt style anchor |
| 134 | tightening knob |
| 136 | barrel nut |
| 140 | short T-bolt style anchor |
| 150 | expandable dog anchor |
| 154 | dog hole |
| 156 | work surface |
| 158 | workpiece |
| 160A, B | expansion components |
| 162 | threaded through-bolt |
| 164 | spring |
| 170A, B | expandable anchor fingers |
| 172 | cylindrical collar |
| 180 | driver handle |
| 210 | movable guide |
| 214 | movable guide central web |
| 216, 218 | movable guide edges |

What is claimed is:

1. A clamp apparatus including:
a clamp base having an adjustment slot therein;
a releasable anchor, operatively associated with and passing through the adjustment slot, to attach the clamp base to a work surface; and
a removable tip for attachment on the end of the clamp base for contact with a workpiece.

2. The clamp apparatus of claim 1, wherein the removable tip includes a rigid portion that connects to the clamp base and a resilient portion for contacting a workpiece.

3. The clamp apparatus of claim 2, wherein the resilient portion has a contact surface selected from the group consisting of: a flat surface, a ribbed surface, a low-profile surface and a surface having an array of protrusions.

4. The clamp apparatus of claim 2, wherein the rigid portion of the removable tip includes a receptacle for receiving an end of the clamp base.

5. The clamp apparatus of claim 2, wherein the rigid portion of the removable tip includes a threaded hole and where the apparatus further includes a threaded bolt for removably connecting the clamp base to the removable tip.

6. The clamp apparatus of claim 1 wherein the anchor is selected from the group consisting of: a threaded screw, a T-bolt with a tightening knob, and a dog anchor.

7. The clamp apparatus of claim 1 wherein the anchor is a dog anchor comprising two expansion components arranged to opposedly contact one another and a threaded bolt passing through both expansion components, the dog anchor being suitable for insertion into a dog hole in the work surface and expanding to releasably anchor the clamp to the work surface.

8. The clamp apparatus of claim 7 wherein the two expansion components are identical in shape and one is reversed relative to, and overlaps, the other.

9. The clamp apparatus of claim 8 wherein the fingers of the two expansion components are in contact when the two expansion components are compressed longitudinally, creating an axial force against a dog hole.

10. The clamp apparatus of claim 1 wherein the adjustment slot is surrounded by a high-friction surface and at least a portion of the releasable anchor contacts the high-friction surface to hold the clamp base in place when attached to the work surface.

11. The clamp apparatus of claim 10 wherein the high-friction surface includes a plurality of parallel ridges along and extending from the sides of the adjustment slot, and where the releasable anchor further includes a collar with a complimentary ridged under-surface for frictional contact with the parallel ridges.

12. A movable guide for use on a work surface comprising:
a central web spanning between at least two opposite edges, wherein at least one of the edges includes a ribbed surface for contact with a workpiece;
a slot located in the web; and
an anchor, adjustably associated with the adjustment slot, for releasably positioning the guide relative to a dog hole in a work surface.

13. The movable guide of claim 12, wherein the anchor is a dog anchor comprising two expansion components arranged to opposedly contact one another and a threaded bolt passing through both expansion components, the dog anchor being suitable for insertion into the dog hole in the work surface and expanding to releasably anchor the guide to the work surface.

14. The movable guide of claim 13 wherein the two expansion components are identical in shape and one is reversed relative to, and overlaps, the other.

15. The movable guide of claim 14 wherein the fingers of the two expansion components are in contact when compressed longitudinally, creating an axial force against the dog hole.

16. A releasable anchor, for use with a dog hole in a work surface, comprising:
two identical expansion components opposedly contacting one another; and
an adjustable fastener passing through each of the expansion components,
wherein the anchor is suitable for insertion into the dog hole and in response to a compressive force applied by the threaded expanding to provide a releasably contact to the work surface.

17. The releasable anchor of claim 16 wherein the two expansion components are identical in shape and one is reversed relative to, and overlaps, the other.

18. The releasable anchor of claim 17 where each expansion component has a plurality of fingers, and wherein the fingers of the two expansion components are in contact when compressed longitudinally, creating an axial force against the dog hole.

19. The releasable anchor of claim 17 where the fingers of the each expansion component extend from a cylindrical collar, and wherein fingers of the opposed expansion components interfere as the respective cylindrical collars are moved toward one another by a compressive force, where the interference causes the fingers to deflect and expand to contact a wall of the dog hole.

20. The releasable anchor of claim 19 wherein the fingers have at least one shoulder thereon, the shoulder of each finger interlocking with an adjacent finger of an opposed expansion component to connect the two expansion components.

21. The releasable anchor of claim 19 further comprising a spring, located between the collars of the opposed expansion components to bias expansion components away from one another (where the components are in a non-expanded configuration).
